(19) United States
(12) Patent Application Publication
(10) Pub. No.: US 2003/0037325 A1
(43) Pub. Date: Feb. 20, 2003

(54) System and methods for automatically installing a correct software version from media containing multiple software versions

(76) Inventors: David C. Hargrove, Boise, ID (US); Clifford L. Coppinger, Boise, ID (US); Brett A. Green, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/932,509

(22) Filed: Aug. 17, 2001

(51) Int. Cl. G06F 9/445; G06F 9/44

(52) U.S. Cl. 717/175; 717/170

(57) ABSTRACT

The system and methods described herein relate to automatically installing a correct software version onto a computer from a software distribution medium that stores multiple installable versions of the same software product (i.e., a multi-version software distribution medium). A double INF file architecture on the multi-version software distribution medium relieves a user of the burden of directing an installation program (e.g., a hardware/software installation Wizard) to a specific location within the medium to complete the installation of the correct software version. The user need only direct the installation program to the distribution medium. The double INF file architecture ensures an automatic installation of the correct software version without the need for understanding how to navigate the medium.

### TECHNICAL FIELD

The present invention relates to software installation, and more particularly, to automatically installing the correct software version from media that contain multiple operating system and language versions of the same software.

### BACKGROUND

Computing devices such as personal computers (desktop PCs, laptop PCs, pocket PCs, etc.) typically implement an operating system based on a particular localized language. For example, personal computers in France implement operating systems that facilitate the transfer of information between a user and the computer in French. In addition to numerous languages supported by various operating systems, a particular operating system typically varies from computer to computer depending on the version of the operating system installed on the computer. Thus, four computers might have four different versions of the same general operating system (e.g., Windows® 95, Windows 98, Windows 98SE, Windows ME).

Windows operating systems utilize an INF file (i.e., an INFormation file) architecture that facilitates software installation. An INF file is a simple text file organized into named sections. Each section contains specific entries and/or directives that reference additional sections specified elsewhere in the INF file. The sections, entries, and directives have specific purposes such as copying files from the software distribution media (e.g., optical disks, floppy disks), installing a driver service, or adding or modifying value entries in registry keys.

In a typical software installation onto a Windows-based computer, a user initiates a software/hardware installation program often called an installation Wizard. The user is prompted to direct the Wizard to a software distribution medium (e.g., a CD located in drive D) where it looks for an INF file. The Wizard uses information in the INF file to ensure that the correct files are located and copied onto the computer to complete the software installation. Thus, companies producing software and software/hardware products for implementation on Windows-based computers can work within the INF file architecture to provide INF files that meet their particular software installation needs.

Companies selling software and software/hardware products for implementation on computers throughout the world, however, often encounter customer dissatisfaction related to the installation of software. A printer manufacturer, for example, may have to devote significant resources to service customer complaints and inquiries regarding the installation of printer device software onto a personal computer. The difficulty stems from the manufacturer's need to include numerous software versions on the product distribution media to accommodate the various operating system and localized language requirements that may be encountered throughout the world.

Under such circumstances, a distribution medium such as a CD is typically configured with numerous subdirectories, each subdirectory containing files required for the installation of a particular software version. Each subdirectory additionally contains a specific INF file that provides the Wizard with information to complete the installation of the particular software version. Unfortunately, a “multi-version” software distribution medium configured in this manner creates a problem for the installation Wizard during a typical installation.

As discussed above, during a typical installation a user initiates the installation program/Wizard and directs it to a software distribution medium such as a CD located in drive D. However, where the CD is a multi-version software distribution medium configured with subdirectories containing various INF and other installation files, the Wizard fails to locate an INF file. This is because the Wizard only looks in the root directory and not the individual subdirectories for the INF file. Therefore, the Wizard typically responds to the user with some type of statement indicating an installation failure has occurred, such as, “The specified location does not contain information about your software/hardware.” Most users then do not know how to proceed and must resort to calling the manufacturer's service department to be talked through the installation procedure.

An installation procedure thereafter requires the user to understand how to navigate the multi-version software distribution medium and point the Wizard to the correct subdirectory to locate the particular INF file that assists the Wizard in completing the installation. This typically requires that the user understand how to navigate the medium to find the directory that corresponds to the user's operating system type and version as well as the system's localized language. Although some experienced users have little problem with this process and therefore do not need to seek assistance, they are nevertheless required to manually locate the appropriate INF file to complete the installation, which can be time consuming and tedious.

Accordingly, the need exists for a way to automatically install the correct software version from a multi-version software distribution medium. In addition, an automatic installation capability should leave intact the current method of manually locating a correct INF file so as not to create an alternate problem for experienced users who are familiar with navigating such multi-version software distribution media.

### SUMMARY

Installation data on a software distribution medium includes a double INF file architecture that permits the automatic installation of a correct software version onto a computer where multiple software versions are present on the distribution medium. The double INF file architecture includes a single root INF file and multiple secondary INF files, each secondary INF file corresponding to a particular operating system or language-specific files present on the distribution medium.

The root INF file is configured to automatically control the installation of any one of the available software versions onto a computer. The correct software version to be installed on the computer depends on what operating system is being implemented on the computer. Thus, the correct software version depends on the localized language or country code of the operating system, as well as the version of the operating system.

The root INF file is logically located within a root directory on the multi-version software distribution medium and is therefore automatically locatable by an installation program or Wizard executing on the computer. The root INF file includes various named sections that contain installation information. The installation program locates and uses only the named sections that correspond to the localized language and operating system version of the computer. Information from appropriate sections within the root INF file directs the installation program to appropriate source files that are used to complete the installation of the correct software version.

If the root INF file is not used for a software installation, a secondary INF file can be used that is manually locatable by the computer user. Secondary INF files are logically located within subdirectories on the distribution medium. Rather than controlling the installation of any of the available software versions, a secondary INF file is configured to control the installation of a particular software version. Generally, source files for the particular software version are logically located within the same subdirectory as the corresponding secondary INF file used to install the particular software version.

### BRIEF DESCRIPTION OF THE DRAWINGS

The same reference numbers are used throughout the drawings to reference like components and features.

FIG. 1 illustrates a system environment suitable for providing an automatic installation of a correct software version onto a computer where multiple software versions are present on a software distribution medium.

FIG. 2 illustrates examples of various types of software distribution media and installation software/data that are suitable for use in a system environment such as that shown in FIG. 1.

FIG. 3 is a block diagram illustrating an example of the internal architecture of a computer such as the computer shown in FIG. 1.

FIG. 4 is a block diagram illustrating an example configuration of a double INF file architecture on a multi-version software distribution medium.

FIG. 5 illustrates example sections within an INF file that might be found on a multi-version software distribution medium.

FIG. 6 is a flow diagram illustrating an example method of automatically installing a correct software version onto a computer where multiple software versions are present on a software distribution medium.

### DETAILED DESCRIPTION

The system and methods described herein relate to automatically installing a correct software version onto a computer from a software distribution medium that stores multiple installable versions of the same software product (i.e., a multi-version software distribution medium). A double INF file architecture on the multi-version software distribution medium relieves a user of the burden of directing an installation program (e.g., a hardware/software installation Wizard) to a specific location within the medium to complete the installation of the correct software version. The user need only direct the installation program to the distribution medium. The double INF file architecture ensures an automatic installation of the correct software version without the need for understanding how to navigate the medium.

The double INF file architecture additionally accounts for users who are familiar with manually pointing an installation program to a specific location within the distribution medium to access files needed for installing the correct software version. Accordingly, knowledgeable users accustomed to navigating a multi-version software distribution medium and locating the correct installation files can continue software installations in this manner.

Benefits of the system and methods include a reduced need for technical services related to assisting customers in the installation of software products. This lowers overall service-oriented costs for manufacturers and software vendors who offer products in a worldwide market and increases customer satisfaction in such products.

### Exemplary System for Automatically Installing a Correct Software Version

FIG. 1 illustrates an example of a system environment 100 suitable for automatically installing a correct software version onto a computer where multiple software versions are present on a software distribution medium. Computer device 102 may be implemented as various computing devices, such as servers, workstations, desktop personal computers (PC's), laptop computers, notebook computers, handheld personal digital assistants (PDA's) and the like. Software distribution media 104 may be implemented as various computer storage media, such as read-only memory (ROM), flash memory, a hard disk, a removable floppy disk, a removable optical disk and the like.

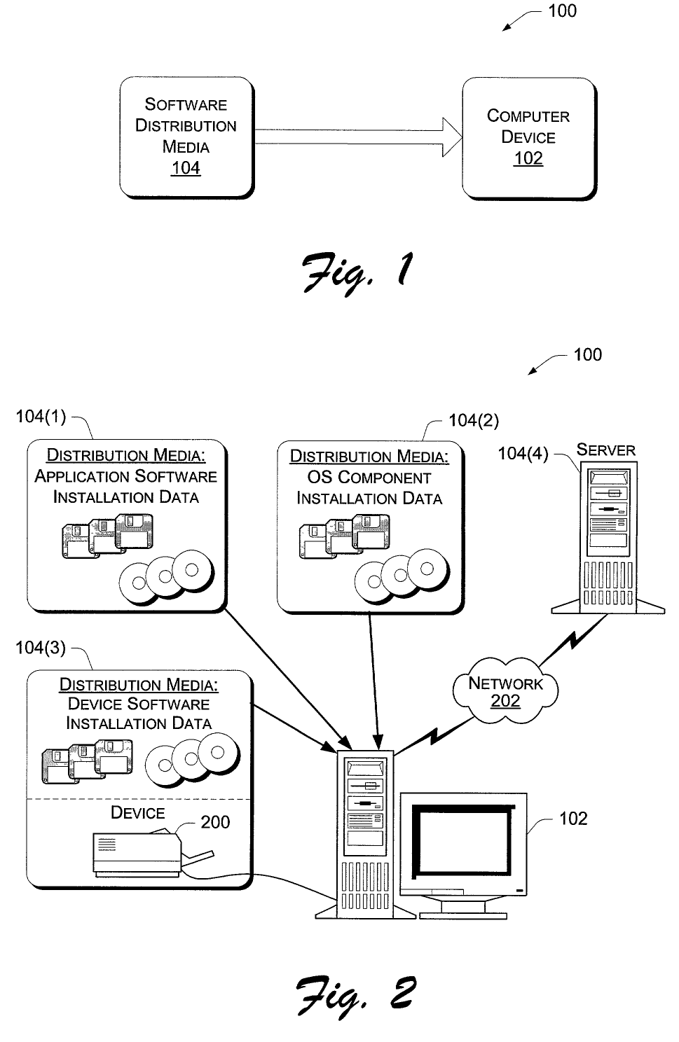

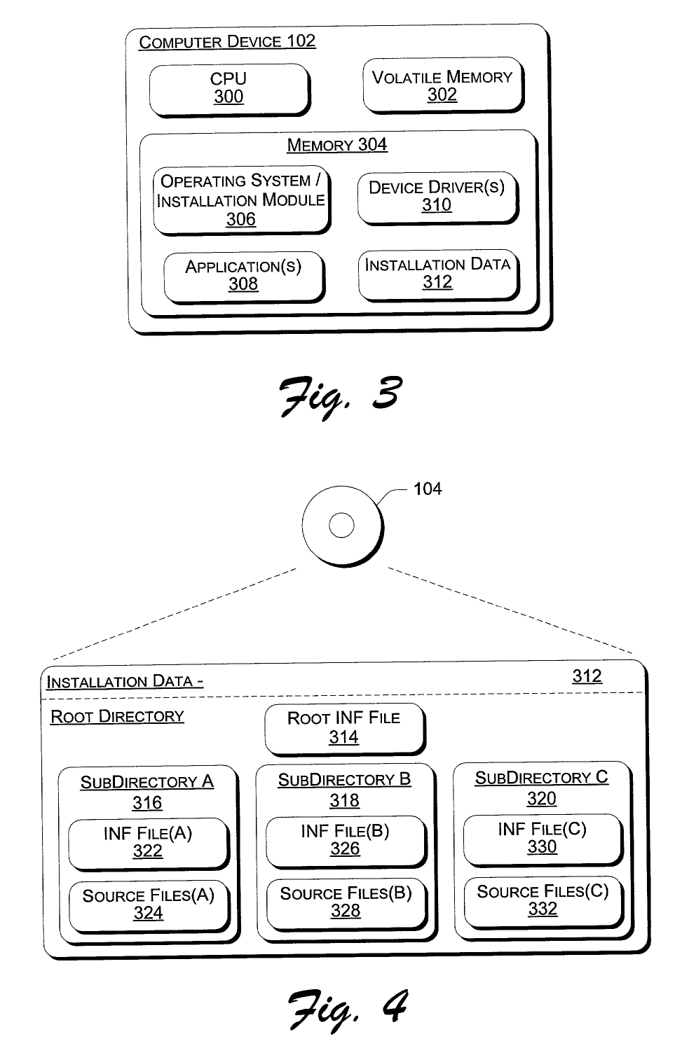

FIG. 2 illustrates examples of various types of multi-version software distribution media 104 and the types of installation software/data that might be stored on such media for use in the system environment of FIG. 1. Distribution media 104(1) shows application software as installation data stored on one or more floppy or optical disks for installation onto computer 102. Likewise, distribution media 104(2) and 104(3) show, respectively, operating system (OS) component software and device driver software stored on one or more floppy or optical disks for installation onto computer 102. Printer device 200 is one example of a peripheral device whose driver software may be installed onto computer 102. Examples of other peripheral devices having driver software that may be installable onto computer 102 include devices such as scanners, copiers, and fax machines, or multifunction peripheral (MFP) devices that combine two or more peripheral devices into a single device.

FIG. 2 additionally illustrates that multi-version software distribution media 104 may be implemented as various computer storage media associated with a remote server 104(4) coupled to computer 102 via a communication link such as network 202. Network 202 can include a LAN (local area network), a WAN (wide area networks), an intranet, the Internet, or any other suitable communication link.

FIG. 3 is a block diagram illustrating an example of the internal architecture of computer 102. In general, computer 102 includes a processor (CPU) 300, a volatile memory 302 (i.e., RAM), and a non-volatile memory 304 (e.g., ROM, hard disk, floppy disk, CD-ROM, etc.). Any number of program modules can be stored in memory 304, including by way of example, an operating system 306, one or more application programs 308, device driver modules 310 and other program data such as installation data 312. Computer 102 may implement such program modules by executing a module's computer-readable instructions on processor 300. For example, computer 102 may implement the software-based device driver 310 stored in memory 304 and executed on the processor 300 to configure data into an appropriate format (e.g., PCL, postscript, etc.) for output to a printer device 200 such as that shown in FIG. 2.

The operating system 306 on computer 102 typically includes an installation module configured to manage software installations for the computer. When initiated by a user, the installation module 306 may manifest itself as an installation Wizard that guides a user through a software installation process. In a typical software installation, a user is prompted to direct the installation module/Wizard 306 to a software distribution medium (e.g., a CD located in drive D) where it looks for installation data 312. The installation data 312 generally includes information about the installation process as well as source files needed to complete the software installation. As discussed above, a software distribution medium 104 may be implemented as various computer storage media including ROM, flash memory, a hard disk, a removable floppy disk, a removable optical disk and the like. Accordingly, FIG. 3 illustrates the installation data 312 as being stored in memory 304, which may, for example, include a number of different storage components such as a number of different optical or floppy disks.

As part of a typical software installation process, the installation module 306 further locates an INF file within the installation data 312. The installation module 306 uses information in the INF file to ensure that appropriate source files are located and copied onto the computer 102 to complete the software installation. Thus, as a software installation proceeds, the installation module 306 may prompt a user to insert different numbered disks from the software distribution medium 104 into computer 102 in order that all the necessary source files can be properly accessed.

### Exemplary INF File Architecture for Automatically Installing a Correct Software Version

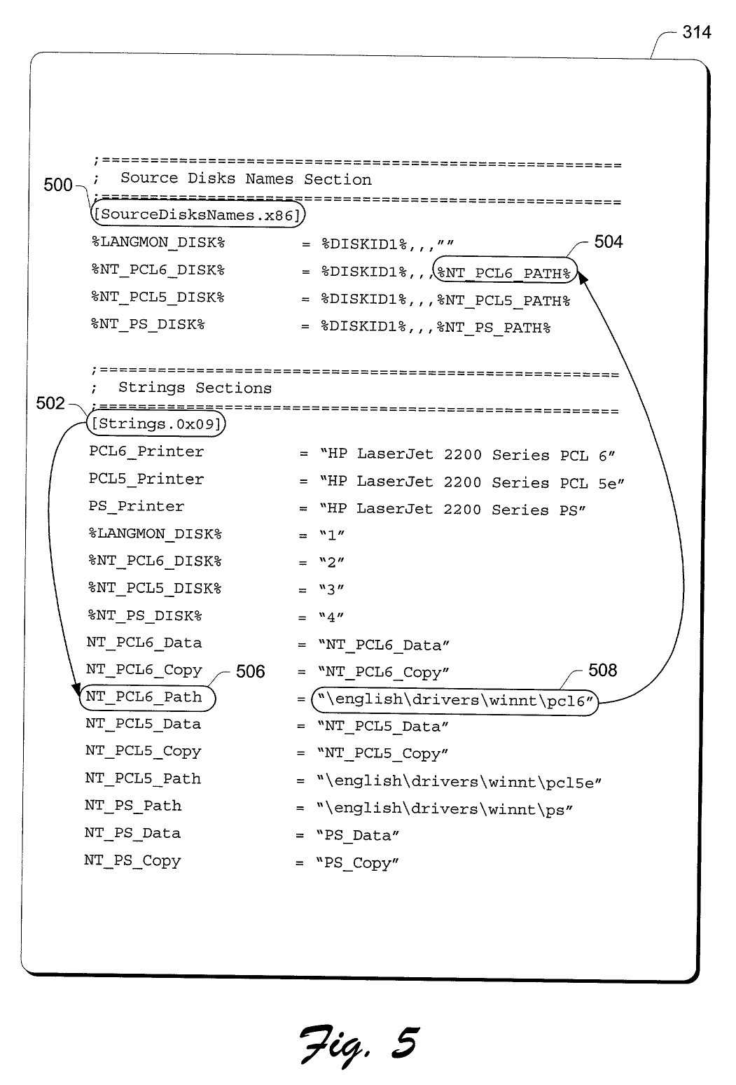

FIG. 4 illustrates an example configuration of a multi-version software distribution medium 104 that incorporates a double INF file architecture. The double INF file architecture includes a root INF file 314 and multiple secondary INF files 322, 326, and 330. As explained more fully below, the double INF file architecture permits the automatic installation of a correct software version from a multi-version software distribution medium 104. Although the distribution medium 104 of FIG. 4 is shown as a single optical disk, it may also be embodied as a plurality of optical disks or as any of the various computer storage media previously discussed, including any suitable number and/or combination of such media.

The configuration of the multi-version software distribution medium 104 (FIG. 4) includes the installation data 312 located in both a root directory and multiple subdirectories. Specifically, the root INF file 314 is located in the root directory while the various secondary INF files (322, 326 and 330) and source files (324, 328, and 332) are located in subdirectories of the root directory. By way of example, and not limitation, FIG. 4 illustrates three subdirectories on the multi-version software distribution medium 104: subdirectory A 316, subdirectory B 318, and subdirectory C 320. Respectively, the contents of these three subdirectories include secondary INF file (A) 322 and source files (A) 324, secondary INF file (B) 326 and source files (B) 328, and secondary INF file (C) 330 and source files (C) 332.

The source files within a particular subdirectory represent a particular version of the software product to be installed. For example, source files (A) 324 may represent a software version configured to be installed on a computer 102 that implements a Windows NT operating system in the local language of French, while source files (B) 328 may represent a software version configured to be installed on a computer 102 that implements a Windows 98 operating system in the local language of German.

It is noted that references in this document to the location of a root directory or subdirectory within a distribution medium 104 are logical references only. That is, a root directory or subdirectory, as well as the contents of such directories, may be physically located on various parts of a distribution medium 104 or distribution media 104 regardless of what the discussion and/or illustrations herein might otherwise imply. Thus, while FIG. 4 illustrates subdirectories A, B, and C (316, 318, 320) as being physically located on a single optical disk (distribution medium 104), they and their contents may actually be physically located on a number of optical disks or other computer storage media.

Automatic installation of a correct software version from a multi-version software distribution medium 104 is controlled primarily by the root INF file 314 in the root directory. Because current installation modules/Wizards 306 do not search for INF files in subdirectories, software installations fail when software distribution media are not configured with an INF file in a root directory. Therefore, because prior multi-version software distribution media are configured with INF files in various subdirectories rather than in a root directory, installations from such prior media require users to manually navigate the media in order to point the installation module/Wizard 306 to a correct subdirectory containing an INF file and source files corresponding to a particular desired software version.

The root INF file 314 avoids this problem in two ways. First of all, the root INF file 314 is locatable by installation modules/Wizards 306 that are configured to search for an INF file in a root directory of a software distribution medium. Second of all, the root INF file 314 is specially configured to direct an installation module/Wizard 306 to an appropriate subdirectory containing source files that correspond to a correct software version.

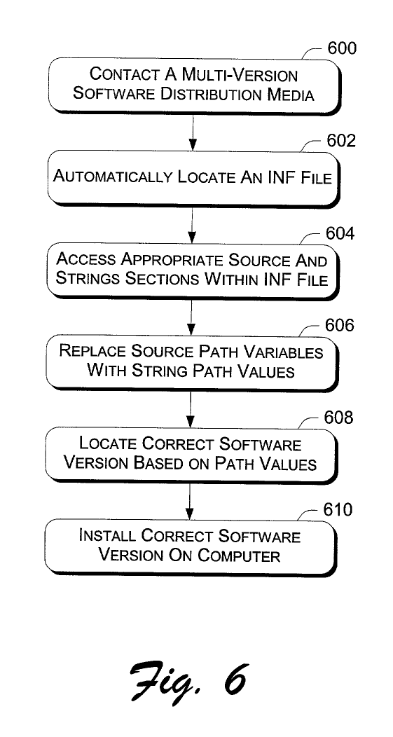

FIG. 5 illustrates an example of two named sections within a root INF file 314 that are configured to properly guide an installation module/Wizard 306 to a location within a multi-version software distribution medium 104 where source files can be found that are needed to complete an installation of a correct software version. A correct software version is determined by a particular localized language and a particular operating system version.

As illustrated in FIG. 5, sections within the root INF file 314 include section name extensions that indicate to an installation module/Wizard 306 a country code (i.e., a local language) and an operating system version. The sections illustrated in the example of FIG. 5 that are recognizable by an installation module/Wizard 306 are the “[SourceDisksNames.x86]” 500 section and the “[Strings.0×09]” 502 section. In an actual root INF file 314 there are numerous “[SourceDisksNames]” sections and “[Strings]” sections, each having name extensions indicating an operating system version and a local language or country code. The installation module/Wizard 306 searches through the root INF file 314 and uses only those sections that correspond to the operating system and local language of the computer 102 on which the installation module/Wizard 306 is running.

Thus, the “[SourceDisksNames.x86]” 500 section contains information that tells an installation module/Wizard 306 what source files (e.g., Source Files (A) 324) are needed for a software installation onto a computer 102 that runs an Intel processor (i.e., “.x86”) on any Windows platform (e.g., Windows NT, Windows 95, Windows 98, Windows 98SE, Windows ME). If the installation module/Wizard 306 were executing on a computer 102 running a different processor and/or platform, it would use a “[SourceDisksNames]” section having a different extension. For example, the extension “.ntx86” corresponds to a computer 102 running an Intel processor (i.e., “.x86”) on a Windows NT (i.e., “nt”) platform. In addition to telling the installation module/Wizard 306 what source files are needed for a software installation, the “[SourceDisksNames.x86]” 500 section provides a directory path and disk identification number (if necessary), telling the installation module/Wizard 306 where to look for the source files (e.g., Subdirectory A 316 on media disk 4).

However, because a multi-version software distribution medium 104 contains multiple versions of installable software, the location of the appropriate source files changes depending on the software version to be installed. For example, the source file location for a software installation onto a computer 102 running a Windows NT operating system in French is different than the source file location for a software installation onto a computer 102 running a Windows 98 operating system in German. Therefore, directory paths (and disk identification numbers) shown in the “[SourceDisksNames.x86]” 500 section are variables that are defined by an appropriate “[Strings]” section within the root INF file 314.

Generally, an installation module/Wizard 306 first accesses the appropriate “[Strings]” section within the root INF file 314, so that it knows what values to substitute for variables it encounters in other named sections of the file 314, such as the “[SourceDisksNames.x86]” 500 section. In the “[Strings.0×09]” 502 section of FIG. 5, the extension “.0×09” is a country code that indicates the local language of English. Other example extensions might include “.0×10” for French and “.0×1” for Spanish. Thus, an installation module/Wizard 306 executing on a computer 102 running on a platform with an English language country code, would use the information from the “[Strings.0×09]” 502 section in the root INF file 314 of FIG. 5.

In an example software installation using the sample sections within the root INF file 314 of FIG. 5, an installation computer 102 is assumed to be running an Intel processor on an English language Windows NT platform. Accordingly, the installation module/Wizard 306 executing on computer 102 knows to use the “[SourceDisksNames.x86]” 500 section and the “[Strings.0×09]” 502 section. Note that the platform could be any of a number of different platforms such as a Windows 9x (e.g., Windows 95, Windows 98, Windows 98SE, Windows ME) platform.

The software installation illustrated by FIG. 5 is a device driver software installation for a “Hewlett-Packard Laserjet 2200 Series PCL 6” printer. FIG. 5 illustrates how the “%NT_PCL6 PATH%” variable 504 in the “[SourceDisksNames.x86]” 500 section is replaced with the “NT_PCL6_Path” string 506 that is defined in the English language “[Strings.0×09]” 502 section. Specifically, the path string “\english\drivers\winnt\pcl6” 508 from the “[Strings.0×09]” 502 section replaces the “%NT_PCL6_PATH%” variable 504 from the “[SourceDisksNames.x86]” 500 section. Thus, by virtue of the location and configuration of the root INF file 314 on the software distribution medium 104, the installation module/Wizard 306 automatically knows where to access source files for installation of the correct device driver software version, even though there are multiple language and operating system versions of the device driver software on the software distribution medium 104.

Example secondary INF files (A) 322, (B) 326, and (C) 330, located respectively in subdirectories A 316, B 318, and C 320, as illustrated in FIG. 4, make up the second part of the double INF file architecture. Each secondary INF file is configured to provide an installation module/Wizard 306 with installation information (e.g., source file names and locations) regarding a particular software version if the installation module/Wizard 306 has been specifically directed to that particular secondary INF file. Under these circumstances, the root INF file 314 would have been manually bypassed by a user who is accustomed to navigating a multi-version software distribution medium 104.

The secondary INF files are provided as a way to leave intact, the original method of software installation from a multi-version software distribution medium 104 (i.e., experienced users navigating the medium 104 and locating an appropriate INF file). Providing the root INF file 314 without providing the secondary INF files would remove confusion for some users while causing confusion for others. Thus, the double INF file architecture serves to make software installations easier for all customers, thereby benefiting manufacturers and software vendors by increasing overall customer satisfaction in their products.

### Exemplary Method for Automatically Installing a Correct Software Version

An example method for automatically installing a correct software version onto a computer 102 from a multi-version software distribution medium 104 will now be described with primary reference to FIG. 6. The method applies generally to the system and components illustrated in FIGS. 1-5.

FIG. 6 is a flow diagram that shows an example of a general method for automatically installing a correct software version onto a computer 102 from a software distribution medium 104 that stores multiple installable versions of the same software. At block 600, the method begins with an installation module/Wizard 306 making contact with a multi-version software distribution medium 104. This occurs in a normal installation process when a user directs the installation module/Wizard 306 to the correct location to access the distribution medium 104 (e.g., drive D to access a removable optical disk).

The method continues at block 602 with the installation module/Wizard 306 automatically locating an INF file in the root directory of the multi-version software distribution medium 104. At block 604, the installation module/Wizard 306 accesses the appropriate source section and strings section within the INF file that correspond to the local language and operating system version of the computer 102 on which the software is being installed. Path variables within the source section are replaced by path values defined in the strings section at block 606. The path values point to specific locations on the multi-version software distribution medium 104 where source files to a correct software version can be found.

At block 608, the installation module/Wizard 306 locates the correct software version (source files), and at block 610, the software is installed on the computer 102.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method of installing software on a computer comprising:
contacting a software distribution medium, the software distribution medium comprising multiple software versions for installation on a computer;
automatically locating an INF file; and
installing a correct software version on the computer based on information within the INF file.

2. A method as recited in claim 1, further comprising:
accessing within the INF file, a source section and a strings section that correspond to a country code and a version of an operating system present on the computer;
replacing path variables in the source section with path values from the strings section; and
locating the correct software version based on the path values.

3. A method as recited in claim 1, wherein the INF file is located in a root directory of the software distribution medium and the correct software version is located in a subdirectory of the software distribution medium.

4. A method as recited in claim 2, wherein the correct software version corresponds to the country code and the version of the operating system present on the computer.

5. A method as recited in claim 3, further comprising:
manually locating a secondary INF file within the subdirectory; and
installing the correct software version on the computer based on information within the secondary INF file.

6. A method as recited in claim 1, wherein the software distribution medium is embodied as a computer storage medium selected from a group of computer storage media comprising:
a flash memory;
a hard disk;
read only memory (ROM);
a removable floppy disk; and
a removable optical disk.

7. A method as recited in claim 1, wherein the software distribution medium is a computer storage medium associated with a remote server coupled to the computer device via a network.

8. A software distribution medium comprising:
multiple installable software versions;
a root INF file configured to control a software installation of any one of the multiple software versions; and
secondary INF files, each configured to control a software installation of a particular software version.

9. A software distribution medium as recited in claim 8, further comprising:
a root directory and multiple subdirectories;
wherein the root INF file is located in the root directory and each secondary INF file is located in a distinct subdirectory.

10. A software distribution medium as recited in claim 8, wherein each software version is located in a distinct subdirectory.

11. A software distribution medium as recited in claim 8, wherein each software version corresponds with a localized language and an operating system version.

12. A software distribution medium as recited in claim 8, configured such that a single INF file controls a software installation, the single INF file being either the root INF file or one of the secondary INF files.

13. A software distribution medium as recited in claim 8, wherein the root INF file comprises:
multiple source sections, each source section comprising variable information for installing a software version that corresponds to a particular operating system; and
multiple strings sections, each strings section comprising definitions for the variable information, the definitions corresponding the location of a software version configured in a particular local language.

14. A software distribution medium as recited in claim 8, embodied as a computer storage medium selected from a group of computer storage media comprising:
a flash memory;
a hard disk;
read only memory (ROM);
a removable floppy disk; and
a removable optical disk.

15. A software distribution medium as recited in claim 8, embodied as a computer storage medium associated with a remote server coupled to a computer device via a network.

16. A computer comprising:
a processing unit; and
a memory with installation data, the installation data comprising:
multiple software versions; and
a double INF file architecture configured to direct the processing unit to automatically install a correct software version on the computer.

17. A computer as recited in claim 16, wherein the double INF file architecture further comprises:
a root INF file configured to direct the processing unit to install any one of the software versions as the correct software version on the computer; and
multiple secondary INF files, each secondary INF file configured to direct the processing unit to install a particular software version as the correct software version on the computer.

18. A computer as recited in claim 16, wherein the memory further comprises:
an operating system version operable in a local language; and
wherein the correct software version is determined based on the operating system version and the local language.

19. A computer as recited in claim 16, wherein the memory is a computer storage medium selected from a group of computer storage media comprising:
a flash memory;
a hard disk;
read only memory (ROM);
a removable floppy disk; and
a removable optical disk.

20. A system comprising:
a computer device comprising an installation module; and
a software distribution medium comprising a root INF file located in a root directory and secondary INF files each located in a particular subdirectory, the root INF file configured to direct the installation module to install a correct software version onto the computer device from source files located in any subdirectory, each secondary INF file configured to direct the installation module to install a correct software version onto the computer device from source files located in a particular subdirectory.

21. A system as recited in claim 20, wherein a subdirectory comprises particular source files associated with a particular software version.

22. A system as recited in claim 20, wherein a correct software version depends on an operating system version and local language of the computer device.
